(19) United States
(12) Patent Application Publication
(10) Pub. No.: US 2025/0128966 A1
(43) Pub. Date: Apr. 24, 2025

(54) MATERIALS FOR TREATING ACIDIC MINE WASTEWATER AND PREPARATION METHOD AND USE THEREOF

(71) Applicant: CHINESE RESEARCH ACADEMY OF ENVIRONMENTAL SCIENCES, Beijing (CN)

(72) Inventors: Xiaosong HE, Beijing (CN); Haoqun SHA, Beijing (CN); Ziqian ZHAO, Beijing (CN); Kunhao WEI, Beijing (CN)

(73) Assignee: CHINESE RESEARCH ACADEMY OF ENVIRONMENTAL SCIENCES, Beijing (CN)

(21) Appl. No.: 18/517,002

(22) Filed: Nov. 22, 2023

(30) Foreign Application Priority Data
Oct. 24, 2023 (CN) 2023113870562

(51) Int. Cl. C02F 1/28; C02F 1/66; C02F 101/10; C02F 101/20; C02F 103/10

(52) U.S. Cl. CPC C02F 1/281; C02F 1/66; C02F 2101/101; C02F 2101/203; C02F 2101/206; C02F 2103/10

(57) ABSTRACT

The present invention relates to a material for treating acidic mine wastewater with high concentration, wherein the material is obtained by calcining fly ash with Ca(OH)₂ at high temperature of 600° C. to 800° C., the material can simultaneously remove SO₄²⁻, iron ions, manganese ions in high concentration acidic mine wastewater and significantly increase the pH of the wastewater, is simple to prepare and has good promise in simultaneous removal of multiple metals and inorganic salts in high concentration acidic mine wastewater.

### CROSS-REFERENCE TO RELATED APPLICATIONS

This application claims priority to Chinese Patent Application Ser. No. CN2023113870562 filed 24 Oct. 2023.

### TECHNICAL FIELD

The present invention relates to the technical field of wastewater treatment, in particular to materials for effectively treating acidic mine wastewater with high concentration and their preparation methods and uses.

### BACKGROUND ART

Coal is the world's most widely utilized and used basic energy source. Coal refuse is a solid waste discharged during coal harvesting. Its emissions account for 15%-20% of raw coal yield. Weathering with sulfur and sulfides in refuse mountains produces acidic wastewater rich in sulfates, metals and metalloids. As known as acidic mine wastewater (AMD), AMD is one of the most serious water pollution problems worldwide. Therefore, the development of high concentration acidic mine wastewater remediation or treatment technology and the preparation of corresponding environmental materials is of great importance for water quality safety and water environment improvement.

Fly ash is fine ash captured from flue gas after combustion of coal during pyroelectric power, main components of which are quartz and mullite, about 57%-95% SiO₂, and Al₂O₃. Fly ash is inexpensive, environmentally friendly and highly potent adsorbent. However fly ash is also less chemically active and poorly acid neutralized, which limiting its application in AMD treatment.

Among the materials for treating or remediating acidic mine wastewater that have been developed are predominantly sulfate-reducing bacteria loaded immobilized particles, household garbage-lysing ash composites, and the like, which all have better remediation of treatment effects on acidic mine wastewater (see CN 113354052 B; CN 106861654 B). However, these materials are complicated to prepare, and no remediation application for acidic mine wastewater with heavy metal concentrations of 100 mg/L or higher. The immobilized particulate material loaded with e.g. sulfate reducing bacteria exhibits better heavy metal removal when treating acidic mine wastewater containing various low concentrations of heavy metals at a maximum concentration of 40.4 mg/L, but it does not use to remove multiple metals from high concentration acidic mine wastewater. The household garbage pyrolysis ash composite materials are effective in raising the pH of the wastewater when treating acidic mine wastewater, but without heavy metal removal applications in acidic mine wastewater.

Developing simple, effective, low cost modification process is therefore of great importance for efficient use of coal fines ash for treating acidic mine wastewater with high concentration.

### SUMMARY OF THE INVENTION

The present invention is directed to the problem of simultaneous removal of inorganic salts with multiple heavy metal ions in high concentration acidic mine wastewater, and provides a composite material for treating acidic mine wastewater with high concentration by modifying the fly ash with calcium hydroxide under suitable conditions. The material can simultaneously remove sulfate (SO₄²⁻), iron (Fe) ions, manganese (Mn) ions in high concentration acidic mine wastewater and significantly increase the pH of mine wastewater, is simple to prepare and has good promise in simultaneous removal of multiple metals and inorganic salts in high concentration acidic mine wastewater.

It is an object of the present invention to provide a material for treating acidic mine wastewater with high concentration, wherein the material is obtained by calcining fly ash with Ca(OH)₂ at a high temperature of 600° C. to 800° C.

It is another object of the present invention to provide a method for the preparation of the material for treating acidic mine wastewater with high concentration, which comprising:
(1) collecting and pretreating raw material: fly ash is collected from a power plant and sieved after drying;
(2) compounding and calcining of raw materials: the sieved fly ash is thoroughly mixed with analytically pure Ca(OH)₂ and then calcineed at high temperature of 600° C. to 800° C., with natural cooling after calcining.

Still another object of the present invention is to provide the use of the wastewater treatment material for simultaneous removal of multiple metals including iron ions and manganese ions, and inorganic salt ions including sulfate ions, from acidic mine wastewater with high concentration.

The wastewater treatment material of the present invention provides efficient simultaneous removal of iron manganese ions as well as sulfate ions when treating acidic mine wastewater with high concentration, and also provides effective wastewater acidity reduction, pH improvement, and good space for use.

### DESCRIPTION OF FIGURES

FIG. 1 shows an XRD spectrum of base-modified fly ash in the prior art;

FIG. 2 shows SEM images of base-modified fly ash in the prior art;

FIG. 3 shows XRD spectra of raw fly ash, calcineed modified fly ash, and modified fly ash calcineed with Ca(OH)₂ in preferred embodiments of the invention;

FIG. 4 shows SEM images of raw fly ash (A, B), calcineed modified fly ash (C, D) and calcineed modified fly ash and Ca(OH)₂ in preferred embodiments of the invention (E, F);

FIG. 5 shows the removal effect of Fe ion at different ash-to-calcium ratios in example 1;

FIG. 6 shows the removal effect of Mn ion at different ash-to-calcium ratios in example 1;

FIG. 7 shows the removal effect of Fe ion by modified fly ash at different calcining temperatures in example 2;

FIG. 8 shows the removal effect of Mn ion by modified fly ash at different calcining temperatures in example 2;

FIG. 9 shows the removal effect of Fe ion by modified fly ash at different calcining times in example 3;

FIG. 10 shows the removal effect of Mn ion by modified fly ash at different calcining times in example 3;

FIG. 11 shows the removal effect of SO₄²⁻ in acidic mine wastewater in example 4;

FIG. 12 shows the increasing effect of of pH of acidic mine wastewater in example 5.

### DETAILED DESCRIPTION OF INVENTION

The present invention will now be described in further detail with reference to the accompanying drawings and preferred embodiments. From these descriptions, the characteristics and advantages of the present invention will become more clearly apparent.

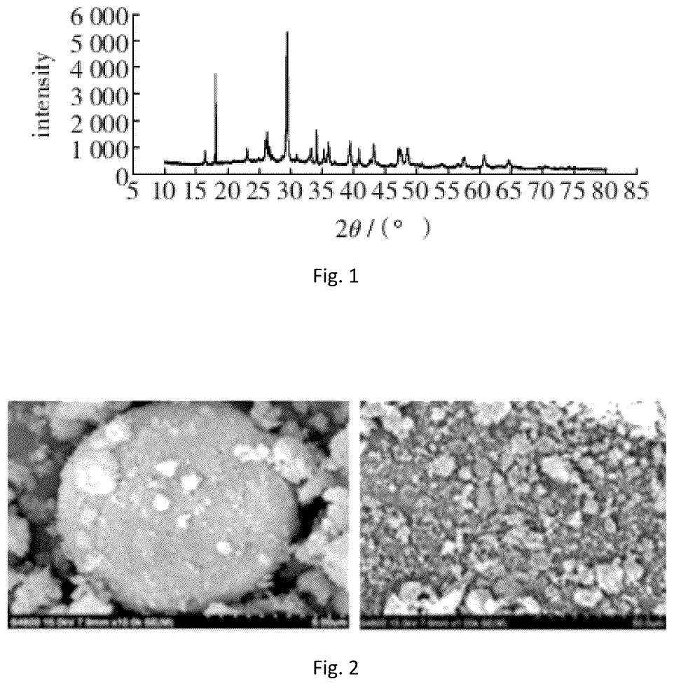

Zhu, Li et al studied removal effect of Cr⁶⁺ by base-modified fly ash from wastewater (Sanshi Chemicals, 2016, 36, p 103-105), but the modified calcination temperature was low, resulting in material structural differences and poor effect in simultaneous removal of multiple metals and inorganic salts from high-concentration acidic mine wastewater. XRD spectra and SEM images thereof are shown in FIGS. 1 and 2.

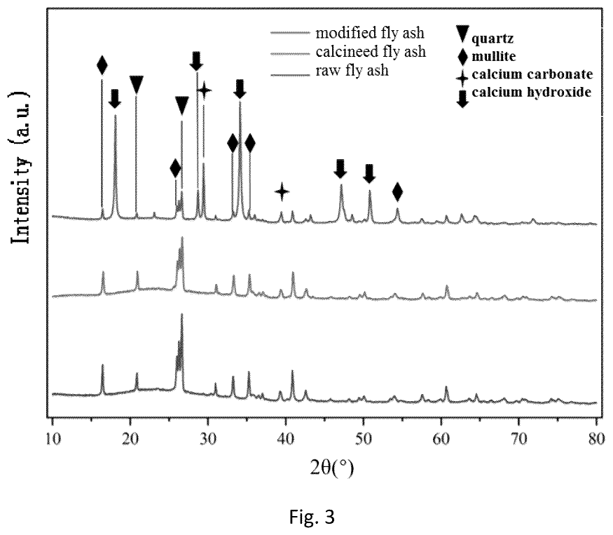

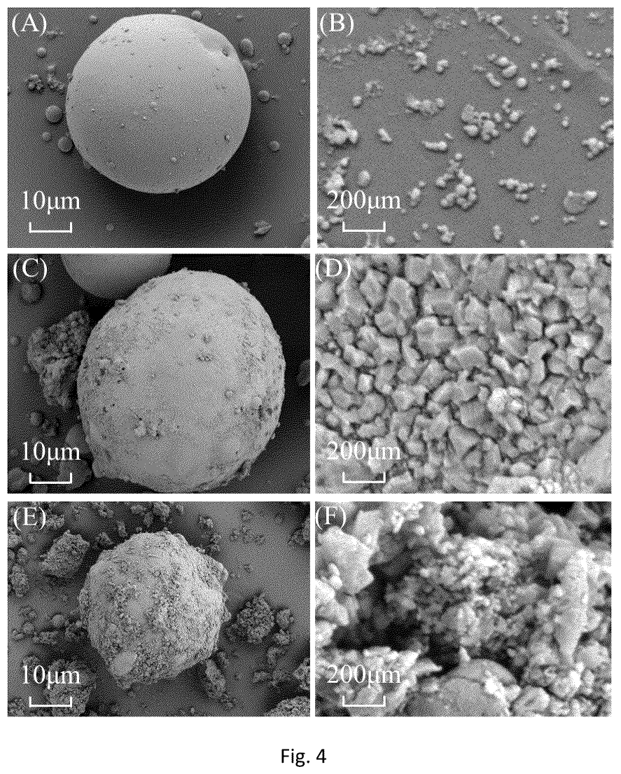

The inventors found that, by mixing calcium hydroxide with fly ash, calcining at high temperature of 600° C. to 800° C., in particular temperature programmed calcination and high temperature calcination at 600° C. to 800° C., XRD spectra (FIG. 3) and SEM images (FIG. 4) of the resulting materials show a clear improvement of the material surface and the crystalline phase structure, with excellent removal of high concentrations of polymetallic ions, especially iron (Fe) and manganese (Mn) ions, while also having good removal of sulfate (SO₄²⁻).

### EXAMPLES

### Example 1

Preparation of composite material for treating high concentration acidic mine wastewater: the collected fly ashes are dried at 90° C., passed through 80 mesh screen, mixed at different ash to calcium ratios (with ash to calcium ratios of 5:1 to 1:3), placed in co-rotating drum blender to mix for 2 hours, then placed in tube resistance furnace, and the furnace temperature is raised to 600° C. at heating rate of 5° C./min, calcinated at 600° C. for 2 hours, and finally cooled naturally to room temperature, to obtain the material for treating high concentration acidic mine wastewater with different ash to calcium ratios.

Formulation acidic mine wastewater having both Fe and Mn concentrations of 100 mg·L⁻¹:0.482 g of FeCl₃.6H₂O and 0.229 g of MnCl₂ are respectively weighed into a beaker, distilled water is added to stir well until completely dissolved, all of the liquid in the beaker is transferred to 1000 mL volumetric flask, then distilled water is continued to be added to 1000 mL, then concentrated nitric acid is dropped to adjust the pH to 1.

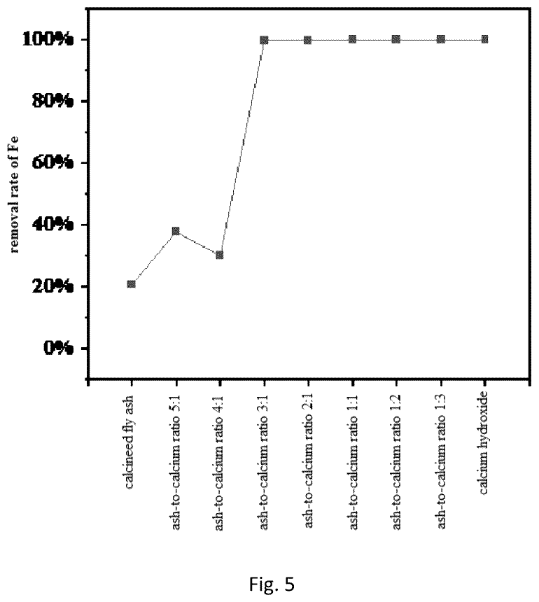

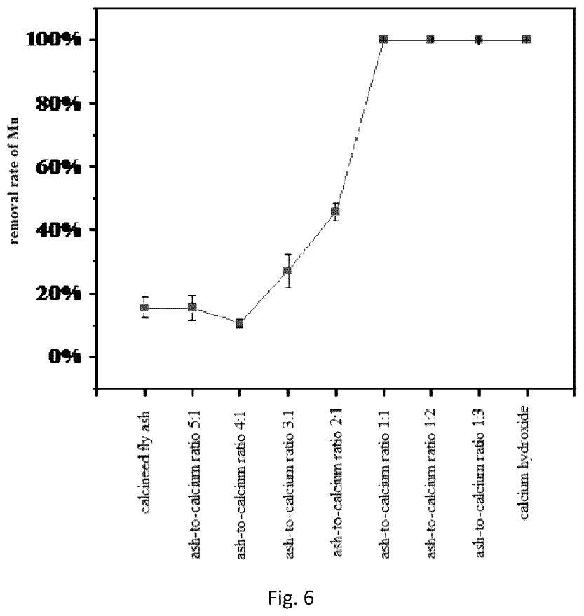

The prepared wastewater treatment materials with different ash to calcium ratios are separately dosed into the formulated acidic mine wastewater at 20 g/L and stirred for 12 hours. The removal effects of Fe and Mn ions by the prepared materials at different ash to calcium compounding ratios are shown in FIG. 5 and FIG. 6. What can see from figures, simultaneous removal effects of Fe and Mn can reach 100% when ash to calcium ratio is above 1:1.

### Example 2

Preparation of composite material for treating high concentration acidic mine wastewater: the collected fly ashes are dried at 100° C., passed through 90 mesh screen, mixed at ash to calcium ratio of 1:1, placed in co-rotating drum blender to mix for 3 hours, then placed in tube resistance furnace, and the furnace temperature is raised to 600, 650, 700, 750, 800° C. at heating rate of 10° C./min, calcinated at 600, 650, 700, 750, 800° C. for 3 hours, respectively, and finally cooled naturally to room temperature, to obtain the material for treating high concentration acidic mine wastewater with different ash to calcium ratios, and allowed to cool naturally to room temperature.

Formulation acidic mine wastewater having both Fe and Mn concentrations of 100 mg·L⁻¹:0.482 g of FeCl₃.6H₂O and 0.229 g of MnCl₂ are respectively weighed into a beaker, distilled water is added to stir well until completely dissolved, all of the liquid in the beaker is transferred to 1000 mL volumetric flask, then distilled water is continued to be added to 1000 mL, then concentrated nitric acid is dropped to adjust the pH to 1.

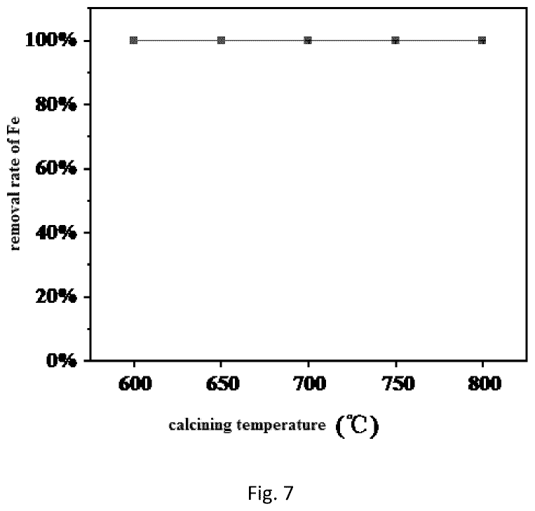

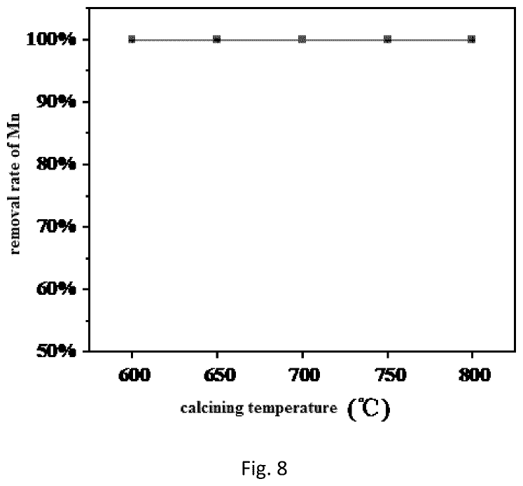

The wastewater treatment materials prepared at different calcining temperatures are separately dosed into the formulated acidic mine wastewater at 30 g/L and stirred for 12 hours. The removal effects of Fe and Mn by the materials prepared at different calcining temperatures are shown in FIG. 7 and FIG. 8. What can see from figures, Fe and Mn simultaneous removal capacities of the materials calcined at 600, 650, 700, 750, 800° C. are all 100%.

### Example 3

Preparation of composite material for treating high concentration acidic mine wastewater: the collected fly ashes are dried at 110° C., passed through 100 mesh screen, mixed at ash to calcium ratio of 1:1, placed in co-rotating drum blender to mix for 3 hours, then placed in tube resistance furnace, and the furnace temperature is raised to 700° C. at heating rate of 10° C./min, calcined at 700° C. for 0.5, 1, 1.5, 2, 3, 4 hours, respectively, and finally cooled naturally to room temperature.

Formulation acidic mine wastewater having both Fe and Mn concentrations of 100 mg·L⁻¹:0.482 g of FeCl₃.6H₂O and 0.229 g of MnCl₂ are respectively weighed into a beaker, distilled water is added to stir well until completely dissolved, all of the liquid in the beaker is transferred to 1000 mL volumetric flask, then distilled water is continued to be added to 1000 mL, then concentrated nitric acid is dropped to adjust the pH to 1.

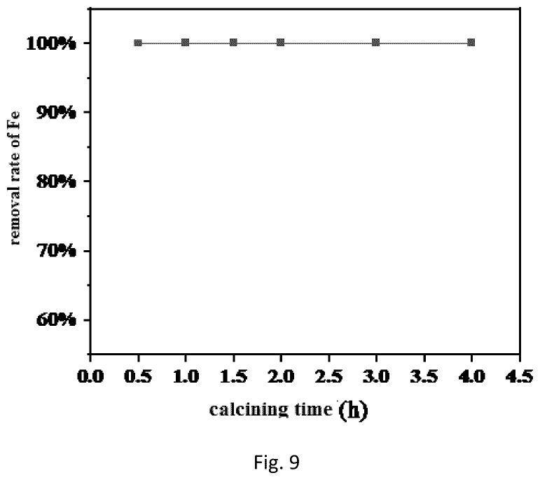

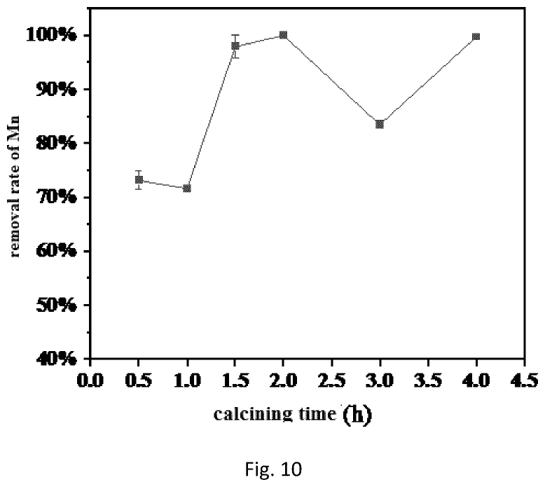

The materials prepared at different calcining times are dosed into the formulated acidic mine wastewater at 20 g/L and stirred for 12 hours. The removal effects of Fe and Mn by the materials prepared at different calcining times are shown in FIG. 9 and FIG. 10. The simultaneous removal of Fe and Mn by the materials at all calcining times is better, with 100% removal of Fe and more than 70% removal of Mn, and the simultaneous removal of Fe and Mn is best when the calcining time is 2 hours or 4 hours.

### Example 4

Preparation of composite material for treating high concentration acidic mine wastewater: the collected fly ashes are dried at 100° C., passed through 100 mesh screen, mixed at ash to calcium ratio of 1:1, placed in co-rotating drum blender to mix for 3 hours, then placed in tube resistance furnace, and the furnace temperature is raised to 700° C. at heating rate of 10° C./min, calcined at 700° C. for 2 hours, and allowed to cool naturally to room temperature.

Modifying fly ash by calcining: the collected fly ash is dried at 100° C., passed through 100 mesh screen, placed in tube resistance furnace, and the furnace temperature is raised to 700° C. at heating rate of 10° C./min, calcineed at 700° C. for 2 hours, and finally cooled naturally to room temperature.

Modifying fly ash with NaOH: the collected fly ash is dried at 100° C., passed through 100 mesh screen, mixed at 1:1 ash-to-sodium ratio, placed in co-rotating drum blender to mix for 3 hours, then placed in tube resistance furnace, and the furnace temperature is raised to 700° C. at heating rate of 10° C./min, calcined at 700° C. for 2 hours, and finally naturally cooled to room temperature.

Formulation acidic mine wastewater with SO₄²⁻ concentration of 1000 mg·L⁻¹: 1.479 g of Na₂SO₄ is weighed and placed in a beaker, appropriate amount of distilled water is added to dissolve well, and the liquid in the beaker is transferred to 1000 mL volumetric flask, then distilled water is added until to 1000 mL, and then concentrated nitric acid is dropped to adjust the pH to 1.

Formulation acidic mine wastewater with SO₄²⁻ concentration of 1000 mg·L⁻¹, both Fe and Mn concentration of 100 mg·L⁻¹: 1.479 g of Na₂SO₄, 0.482 g of FeCl₃.6H₂O and 0.229 g of MnCl₂ are weighed into a beaker respectively, distilled water is added to stir well until completely dissolved, all of the liquid in the beaker is transferred to 1000 mL volumetric flask, then distilled water is continued to be added to 1000 mL, then concentrated nitric acid is dropped to adjust the pH to 1.

The prepared wastewater treatment materials are dosed separately into two formulated acidic mine wastewaters at dosage of 20 g/L and stirred for 12 h.

Limestone, manganese sand, hydrotalcite, raw fly ash, and calcineed modified fly ash, NaOH-modified fly ash and Ca(OH)²-modified fly ash are each dosed into two acidic mine wastewaters formulated at dosage of 20 g/L and stirred for 12 h.

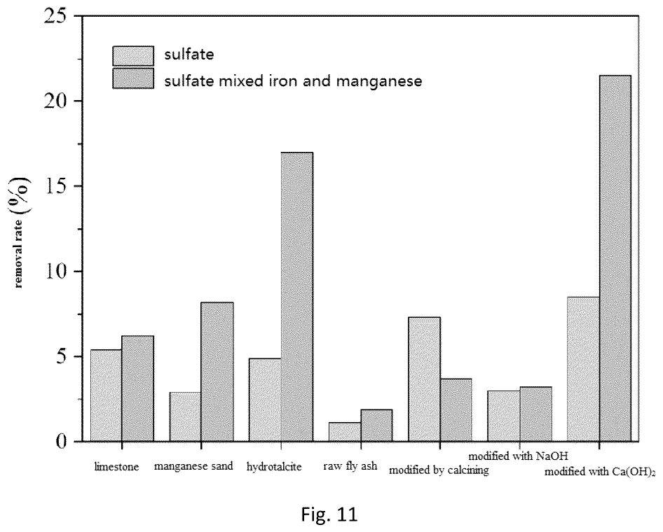

The SO₄²⁻ removal effect of different dosed materials on the acidic mine wastewater with SO₄²⁻ concentration of 1000 mg·L⁻¹ and the acidic mine wastewater with SO₄²⁻ concentration of 1000 mg·L⁻¹, Fe and Mn concentrations of 100 mg·L⁻¹ are shown in FIG. 11. The results show that Ca(OH)₂ modified fly ash performs best simultaneous removal of SO₄²⁻ and Fe and Mn.

### Example 5

Preparation of material for treating high concentration acidic mine wastewater: the collected fly ashes are dried at 100° C., passed through 100 mesh screen, then mixed at 1:1 of ash to calcium ratio, placed in a co-rotating drum blender to mix for 3 hours, then placed in tube resistance furnace, and the furnace temperature is raised to 700° C. at heating rate of 10° C./min, calcined at 700° C. for 2 hours, and cooled naturally to room temperature.

Modifying fly ash by calcining: the collected fly ash is dried at 100° C., passed through 100 mesh screen, placed in tube resistance furnace, and the furnace temperature is raised to 700° C. at heating rate of 10° C./min, and calcineed at 700° C. for 2 hours, and cooled naturally to room temperature.

Modifying fly ash with NaOH: the collected fly ash is dried at 100° C., passed through 100 mesh screen, mixed at 1:1 ash-to-sodium ratio, placed in co-rotating drum blender to mix for 3 hours, then placed in tube resistance furnace, and the furnace temperature is raised to 700° C. at heating rate of 10° C./min, and calcined at 700° C. for 2 hours, and naturally cooled to room temperature.

Formulation acidic mine wastewater with Fe concentration of 100 mg·L¹: 0.482 g of FeCl₃.6H₂O is weighed and placed into a beaker, distilled water is added to stir well until completely dissolved, and all of the liquid in the beaker is transferred to 1000 mL volumetric flask, then distilled water is continued to be added until to 1000 mL, and then concentrated nitric acid is dropped to adjust the pH to 1.

Formulation acidic mine wastewater with Mn concentration of 100 mg·L−1:0.229 g of MnCl₂ is weighed and placed into a beaker, distilled water is added to stir well until completely dissolved, and all of the liquid in the beaker is transferred to 1000 mL volumetric flask, then distilled water is continued to be added until to 1000 mL, and then concentrated nitric acid is dropped to adjust the pH to 1.

Formulation acidic mine wastewater with both Fe and Mn concentrations of 100 mg·L−1:0.482 g of FeCl₃.6H₂O and 0.229 g of MnCl₂ are respectively weighed and placed into a beaker, distilled water is added to stir well until completely dissolved, all of the liquid in the beaker is transferred to 1000 mL volumetric flask, then distilled water is continued to be added to 1000 mL, then concentrated nitric acid is dropped to adjust the pH to 3.

The prepared wastewater treatment materials are dosed into each of three acidic mine wastewaters formulated at dosage of 20 g/L with stirring for 12 h.

Manganese sand, raw fly ash, and calcineed modified fly ash, NaOH-modified fly ash and Ca(OH)²-modified fly ash are each dosed into three acidic mine wastewaters formulated at dosage of 20 g/L and stirred for 12 h.

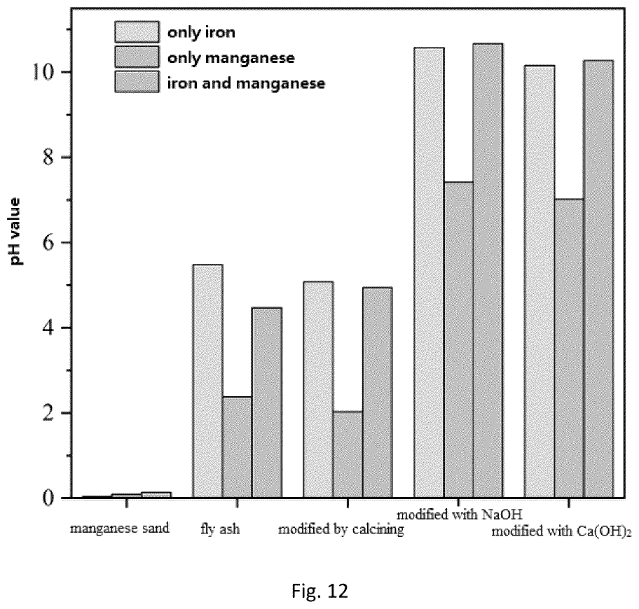

The raising effect of different materials on the pH value of three acidic mine wastewaters is shown in FIG. 12. The results show that Ca(OH)₂ modified fly ash performs best on raising the pH value of acidic mine wastewaters.

The present invention has been described in detail above with reference to preferred embodiments and illustrative examples. It is nevertheless stated that these detailed description and examples are only illustrative explanations of the invention, no limitation is to be placed upon the scope of protection of the invention. Various modifications, substitutions or modifications may be made to the technical disclosure and its embodiments without departing from the spirit and scope of protection of the invention, all falling within the scope of protection of the invention. The scope of protection of the invention shall be subject to the appended claims.

What is claimed is:

1. A material for treating acidic mine wastewater with high concentration, wherein the material is obtained by calcining fly ash with Ca(OH)₂ at a high temperature of 600° C. to 800° C.

2. The material according to claim 1, characterized in that, the weight ratio of fly ash to Ca(OH)₂ is 0.5:1 to 2:1.

3. The material according to claim 1, characterized in that, the weight ratio of fly ash to Ca(OH)₂ is 1:1.

4. The material according to claim 1, characterized in that, the calcining process comprising:
heating to 600° C. to 800° C. at a rate of 5 to 10° C./min followed by calcination at 600° C. to 800° C. for 0.5 to 4 h, preferably 2 h or 4 h.

5. The material according to claim 1, characterized in that,
said fly ash is obtained by collecting recently newly produced fly ash from a coal fired power plant and oven drying at 90 to 110° C., followed by passing through a sieve with 80 to 100 meshes;
the Ca(OH)₂ is analytically pure grade.

6. The material according to claim 1, characterized in that, the fly ash and Ca(OH)₂ are placed in co-rotating drum blender with, mixed for 2-3 h, then calcined at high temperature of 600° C. to 800° C., and cooled naturally to room temperature after calcination.

7. A method for the preparation of the material for treating acidic mine wastewater with high concentration, which comprising the steps of:
(i) collecting and pretreating raw material: fly ash is collected from a power plant and sieved after drying;
(ii) compounding and calcining raw materials: the sieved fly ash is thoroughly mixed with analytically pure Ca(OH)₂ and then calcineed at high temperature of 600° C. to 800° C., with natural cooling after calcining.

8. The method according to claim 7, characterized in that, the weight ratio of fly ash to Ca(OH)₂ is 0.5:1 to 2:1, preferably 1:1.

9. The method according to claim 7, characterized in that, said fly ash is obtained as follows:
recently newly produced fly ash is collected from a coal fired power plant and oven dried at 90 to 110° C. followed by passing through a sieve with 80 to 100 meshes.

10. A process for utilizing the material of claim 1 as simultaneous removal of multiple metals including iron ions and manganese ions, and inorganic salt ions including sulfate ions, from acidic mine wastewater with high concentration.
